(19) United States
(12) Patent Application Publication
(10) Pub. No.: US 2012/0086695 A1
(43) Pub. Date: Apr. 12, 2012

(54) ENVIRONMENTAL PROTECTION ANNOUNCEMENT SYSTEM AND IMPLEMENTATION METHOD THEREOF

(76) Inventor: Kuo-Nien LIU, New Taipei City (TW)

(21) Appl. No.: 13/195,688

(22) Filed: Aug. 1, 2011

(30) Foreign Application Priority Data
Oct. 7, 2010 (TW) 099134225

(51) Int. Cl. G09G 3/34; G09G 5/00

(52) U.S. Cl. 345/212; 345/107

(57) ABSTRACT

An environmental protection announcement system and an implementation method thereof are provided. The environmental protection announcement system includes an announcement device and an information carrier. The information carrier is capable of storing announcement information constructed by an information supply side, so as to enable a user to be in information connection with the announcement device through the information carrier and to drive the announcement device to change display content with a small current. In a normal state, the announcement device does not need an external power supply, thereby achieving the effect of energy saving.

### BACKGROUND OF THE INVENTION

1. Field of Invention

The present invention relates to an environmental protection announcement system and an implementation method thereof, and more particularly, to an environmental protection announcement system and an implementation method thereof that enable an information supply side to be in information connection with an announcement device through an information carrier and change announcement content with a small current.

2. Related Art

In conventional announcement devices, announcement information to be displayed is mainly drawn on a lamp board or paper, and then the lamp board or paper is fixedly disposed on the announcement device, and when it is intended to update display content, another lamp board or paper needs to be drawn for replacement. Therefore, the replacement operation not only takes a lot of works, but also causes waste of resources. Further, during replacement, an adhesive such as a double-sided adhesive tape or an adhesive tape often needs to be used for fixing, so that after multiple times of replacement, residual adhesive is easily left on the announcement device, which affects the overall appearance of the announcement device. Moreover, in the existing announcement devices, in order to make the announcement information more attractive, an optical or electrical display device is generally applied in the structure design, so as to make the announcement information noticeable. However, the electric energy consumed over a long term is considerably large, and during installation, as the power supply and the circuit wiring need to be taken into consideration, the installation site is subject to many limitations.

### SUMMARY OF THE INVENTION

In view of the above problems, the present invention is directed to an environmental protection announcement system and an implementation method thereof that meet the requirements of environmental protection and have the effect of energy saving.

Accordingly, the environmental protection announcement system of the present invention includes an announcement device, for loading announcement information from an information carrier and presenting the announcement information on an electronic paper display unit. Furthermore, as the announcement device uses electronic paper as an interface for displaying the announcement information, transition is caused in photoelectric elements in the electronic paper display unit through a small amount of electric energy provided by the information carrier during connection, so as to present the information to be announced.

### BRIEF DESCRIPTION OF THE DRAWINGS

The present invention will become more fully understood from the detailed description given herein below for illustration only, and thus are not limitative of the present invention, and wherein:

FIG. 1 is a schematic view of configuration of units of the present invention;

FIG. 2 is a schematic view of components of the present invention;

FIG. 3 is a flow chart of the implementation of the present invention;

FIG. 4 is a schematic view I of the implementation of the present invention;

FIG. 5 is a schematic view II of the implementation of the present invention;

FIG. 6 is a schematic view I of configuration of units according to another embodiment of the present invention;

FIG. 7 is a schematic view of the implementation according to another embodiment of the present invention; and

FIG. 8 is a schematic view II of configuration of units according to another embodiment of the present invention.

### DETAILED DESCRIPTION OF THE INVENTION

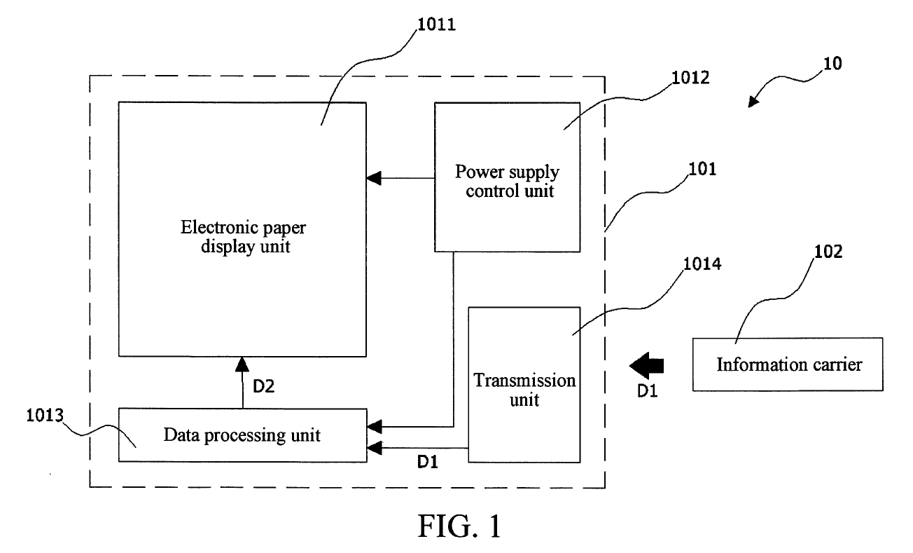

Referring to FIG. 1, an environmental protection announcement system 10 of the present invention mainly includes an announcement device 101 and an information carrier 102. The announcement device 101 includes an electronic paper display unit 1011, a power supply control unit 1012, a data processing unit 1013 and a transmission unit 1014. The electronic paper display unit 1011 may be flexible electronic paper or flexible electrophoretic electronic paper. The electronic paper display unit 1011 is in information connection with the data processing unit 1013, and is used for receiving and presenting image information transferred from the data processing unit 1013. The power supply control unit 1012 is in electrical connection with the electronic paper display unit 1011, the data processing unit 1013 and the transmission unit 1014 respectively, and is used for controlling supply of electric energy required by the units in the announcement device 101. The data processing unit 1013 is in information connection with the transmission unit 1014 and the electronic paper display unit 1011 respectively, and is used for computing and processing announcement information D1 transferred from the transmission unit 1014, and converting the announcement information D1 into image information D2, so as to drive the electronic paper display unit 1011 to generate changes in picture. The data processing unit 1013 has functions of information processing and data recognition. The transmission unit 1014 is in information connection with the data processing unit 1013 and is in electrical connection with the power supply control unit 1012. When the transmission unit 1014 and the information carrier 102 are in connection, the information carrier 102 not only transfers the announcement information D1, but also transfers a small amount of electric energy, so as to enable the announcement device 101 to operate. The transmission unit 1014 may be a Universal Serial Bus (USB). The number of the announcement device 101 may be increased to be several according to requirements for performing different applications such as bulletin boards, billboards, and sign boards. The announcement device 101 uses electronic paper as a display interface, so that in a normal state, the announcement device 101 does not need an external power supply, thereby simplifying the configuration of relevant electrical wiring of the announcement device 101.

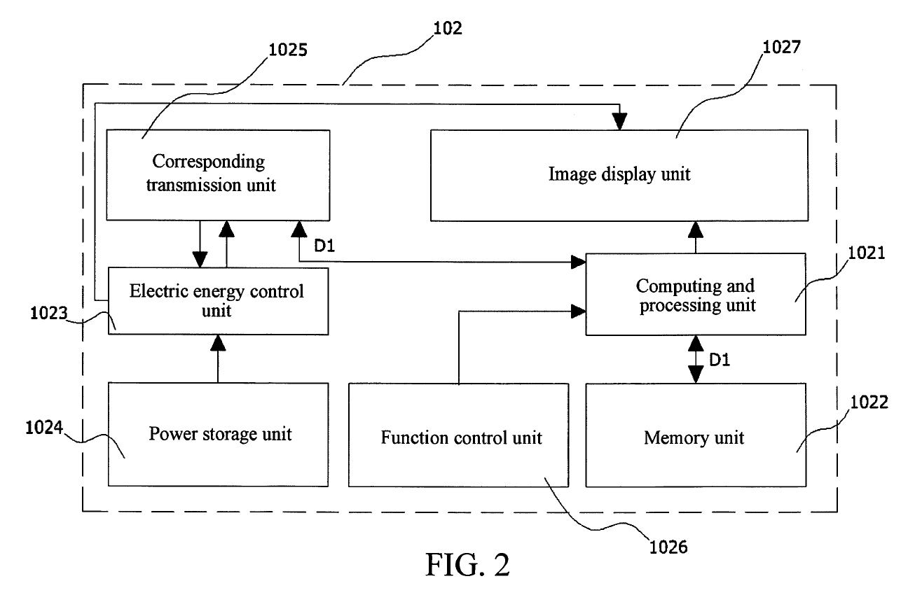

Referring to FIG. 2, the information carrier 102 may be a mobile memory device such as a USB flash drive, and includes a computing and processing unit 1021, a memory unit 1022, an electric energy control unit 1023, a power storage unit 1024 and a corresponding transmission unit 1025. The computing and processing unit 1021 may be a Microprocessor Control Unit, and is mainly used for controlling operations of the information carrier 102 such as data transmission, storage, and image display. The memory unit 1022 is in information connection with the computing and processing unit 1021, and is used for storing information transferred from the computing and processing unit 1021 or extracting stored information for the computing and processing unit 1021 to perform data computing. The memory unit 1022 may be a Flash Memory or a Random Access Memory (RAM). The electric energy control unit 1023 is in electrical connection with the computing and processing unit 1021, the power storage unit 1024 and the corresponding transmission unit 1025 respectively, and is mainly used for controlling supply of electric energy required by the units in the information carrier 102, and controlling charge and discharge of the power storage unit 1024. When the information carrier 102 and the announcement device 101 are in connection, the electric energy control unit 1023 supplies the power stored in the power storage unit 1024 to the announcement device 101 through the corresponding transmission unit 1025, so as to enable the announcement device 101 to operate. The power storage unit 1024 is in electrical connection with the electric energy control unit 1023, is used for storing electric energy and supplying a small amount of electric energy, and may be a chargeable and dischargeable electricity storage element such as a lithium battery, a carbonate battery, and a nickel-hydrogen battery. The corresponding transmission unit 1025 is in information connection with the computing and processing unit 1021, is in electrical connection with the electric energy control unit 1023, and uses the same data transmission interface as that used by the transmission unit 1014. In order to enable the information carrier 102 to have a desirable control function, the information carrier 102 may be configured with a function control unit 1026 and an image display unit 1027. The function control unit 1026 enables a user to control the information carrier 102 to control selection of announcement information, supply of electric energy and the like. The function control unit 1026 is in information connection with the computing and processing unit 1021, and may be a key element or be constructed in the image display unit 1027. The image display unit 1027 is capable of displaying an operation state of the information carrier 102 and relevant information and normally receiving information transferred from the computing and processing unit 1021.

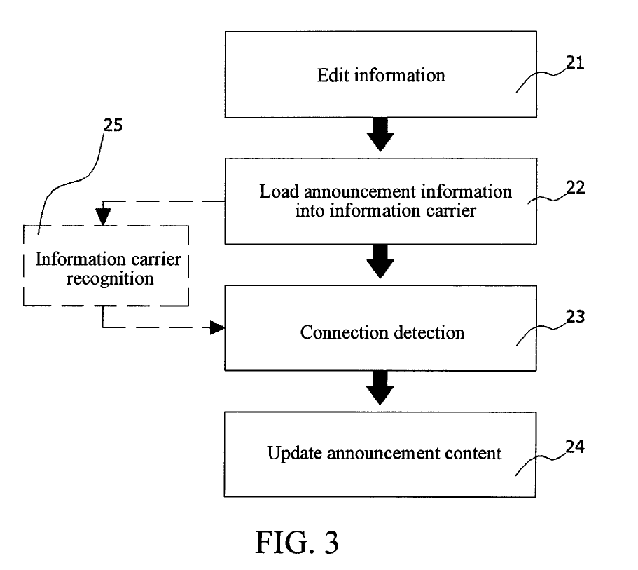

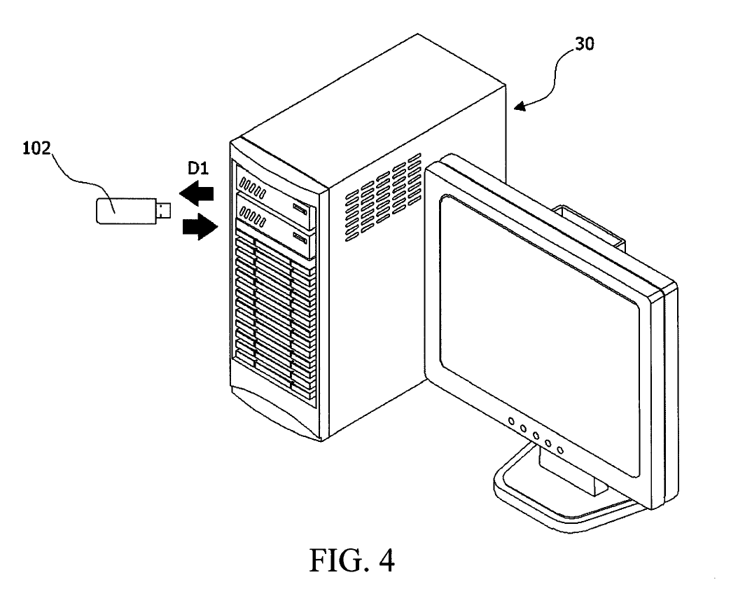

Referring to FIG. 3 together with FIG. 1, FIG. 2 and FIG. 4, when the information supply side intends to update the announcement information D1, the implementation flow is as follows.

(1) Step 21 of editing information. The information supply side makes the information carrier 102 be in information connection with an information apparatus 30, so as to edit announcement information D1 through an editing program loaded in the information apparatus 30. When the information carrier 102 and the information apparatus 30 are in connection, the information apparatus 30 may charge the information carrier 102. At this time, the electric energy control unit 1023 in the information carrier 102 controls electric energy from the information apparatus 30, and transfers the electric energy into the power storage unit 1024.

(2) Step 22 of loading the announcement information into the information carrier: After the announcement information D1 is edited, the announcement information D1 is transferred to the memory unit 1022 in the information carrier 102, and at this time, the information carrier 102 may be disconnected from the information apparatus 30.

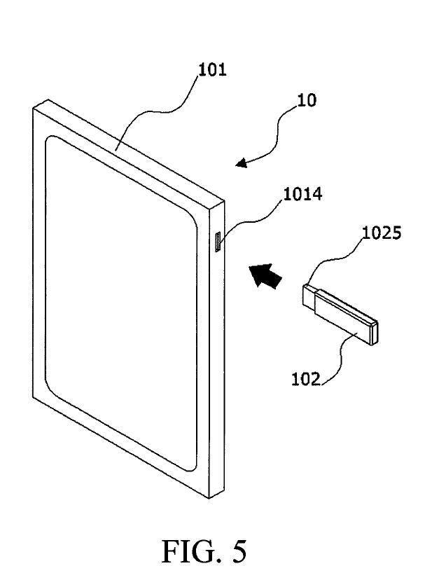

(3) Step 23 of connection detection: Referring to FIG. 5, when the information supply side completes the above steps, the corresponding transmission unit 1025 of the information carrier 102 is made to be in information connection and electrical connection with the transmission unit 1014 of the announcement device 101. At the beginning of connection, the computing and processing unit 1021 in the information carrier 102 detects whether the information carrier 102 is in information connection with the announcement device 101, and if the detection result is NO, the information carrier 102 dose not perform any operation; if the detection result is YES, the information carrier 102 performs a next step.

(4) Step 24 of updating announcement content: It is confirmed that the information carrier 102 is in information connection with the announcement device 101, the electric energy control unit 1023 of the information carrier 102 transfers the electric energy stored in the power storage unit 1024 to the power supply control unit 1012 of the announcement device 101 through the corresponding transmission unit 1025, so as to enable the components inside the announcement device 101 to operate. The announcement information D1 stored in the information carrier 102 is transferred to the data processing unit 1013 of the announcement device 101 through the corresponding transmission unit 1025, and the announcement information D1 is converted into image information D2 through computing of the data processing unit 1013, and transition is further caused when the electronic material on the electronic paper display unit 1011 is driven, so as to change the content of the announcement device 101.

Thus, the information supply side can update the content of the announcement device 101 through the information carrier 102. When the number of the announcement device 101 required in the system is increased, the information supply side only needs to convert the announcement information D1 into electronic information through the information apparatus 30, and then connect the information apparatus 30 to the announcement devices 101 one by one, thereby achieving the objective of changing the announcement devices 101. When the information carrier 102 is in connection with the announcement devices 101, the information supply side may control the information carrier 102 to transfer different announcement information D1 to the announcement devices 101 according to different announcement devices 101. In order to prevent other people from changing the content of the announcement device 101 at will, according to the present invention, Step 25 of information carrier recognition may be added between Step 22 of loading the announcement information into the information carrier and Step 23 of connection detection. As shown in FIG. 3, after the announcement information D1 is stored in the information carrier 102, the information carrier 102 is made to be in information connection with the announcement device 101, so that the announcement device 101 recognizes whether the information carrier 102 connected thereto belongs to the information supply side through the data processing unit 1013, and if the recognition result is No, the announcement device 101 stops operation, so as to prevent improper application by other people.

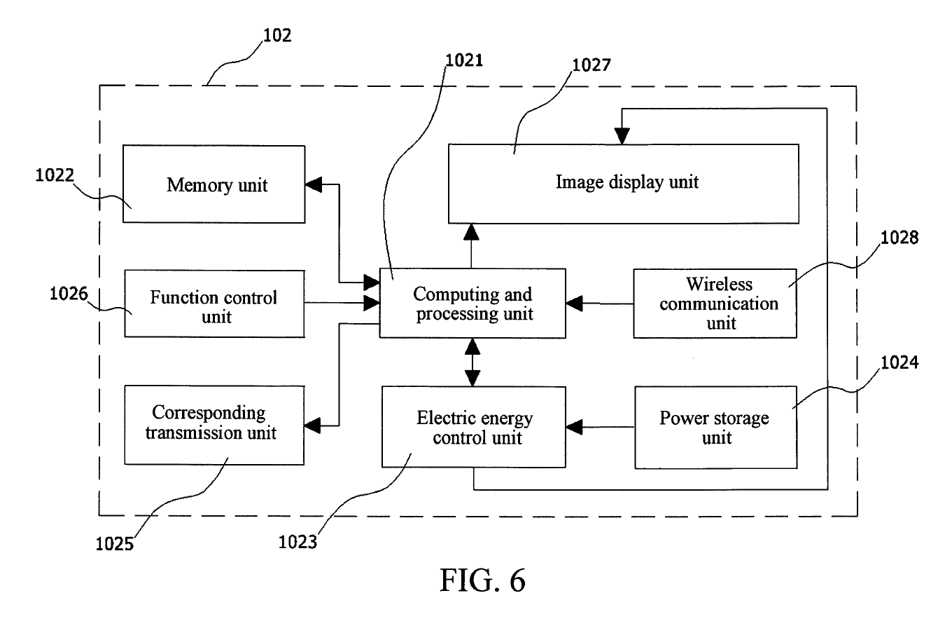

The information carrier 102 of the present invention may be normally in information connection with the announcement device 101. Referring to FIG. 6, the information carrier 102 may be configured with a wireless communication unit 1028, which is in information connection with the computing and processing unit 1021 and is in electrical connection with the electric energy control unit 1023, and is used for receiving information provided by the information supply side. When the information carrier 102 and the announcement device 101 (referring to FIG. 4) are in connection, the information carrier 102 drives the wireless communication unit 1028 to operate, and enables the wireless communication unit 1028 to normally detect whether the information supply side transfers new information. After receiving new information, the wireless communication unit 1028 transfers the received information to the computing and processing unit 1021 for updating the announcement information. The wireless communication unit 1028 may be a wireless communication technology such as radio frequency (RF) transmission.

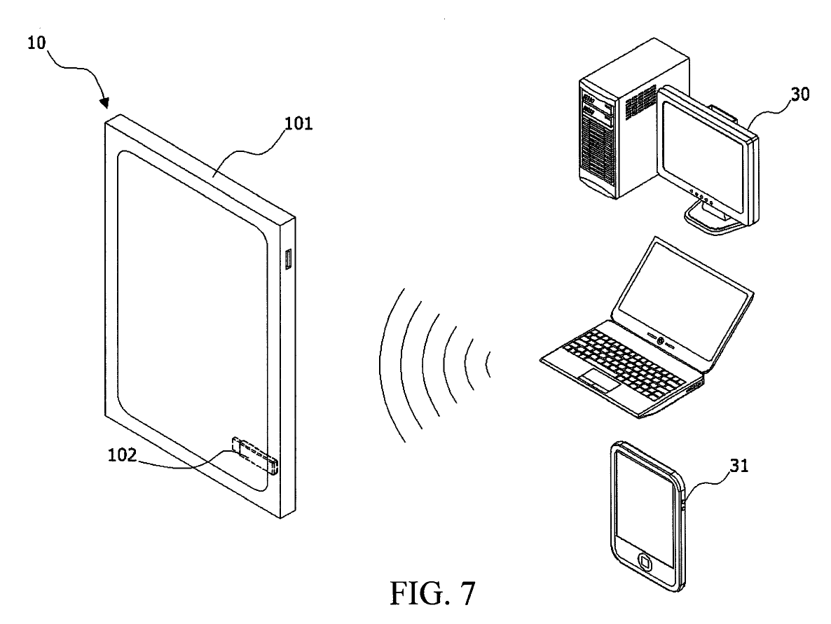

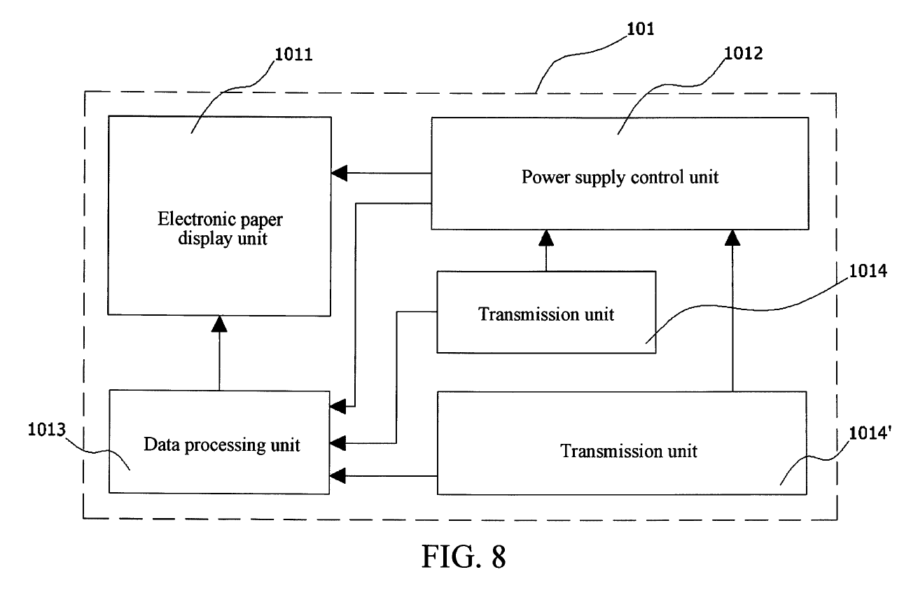

Referring to FIG. 7, when the information carrier 102 and the announcement device 101 are in normal connection, the information supply side may transmit a message through an information apparatus 30 or a portable electronic information device 31, so that the announcement device 101 replaces the announcement information D1, and the flow of the replacement operation is as shown in FIG. 3. When the announcement device 101 operates, the electric energy needed is provided by the information carrier 102, and when the announcement device 101 does not perform any operation in a normal state, the electric energy control unit 1023 in the information carrier 101 stops transferring electric energy to the announcement device 101, so as to reduce the consumption of electric energy in the normal state. Referring to FIG. 8, in this embodiment, another transmission unit 1014′ may be further constructed on the announcement device 101, as shown in FIG. 7. The position where the transmission unit 1014′ is formed is located on an end surface through which the announcement device 101 is installed on a wall surface, and the transmission unit 1014′ is in electrical connection with the power supply control unit 1012, and is in information connection with the data processing unit 1013. The transmission unit 1014′ may use the same communication transmission interface as that used by the transmission unit 1014, and has the same main function as the transmission unit 1014.

Based on the above, according to the present invention, the environmental protection announcement system includes at least one announcement device for loading announcement information from an information carrier and displaying the announcement information on an electronic paper display unit. Furthermore, as the electronic paper display unit is used as a display interface, electric energy does not need to be supplied in a normal state, and only when it is intended to replace the announcement information, transition is caused in photoelectric elements in the electronic paper display unit through a small amount of electric energy transferred from the information carrier, which not only meets the requirements of environmental protection but also simplifies the configuration of electrical wiring. Furthermore, according to the present invention, the information to be announced is converted into electronic information through the information apparatus, and the electronic information is stored in the information carrier, so that the consumption of resources is reduced. Therefore, after the present invention is implemented accordingly, the objective of providing an environmental protection announcement system and an implementation method thereof that meet the requirements of environmental protection and have the effect of energy saving can surely be achieved.

The above descriptions are merely preferred embodiments of the present invention, but are not intended to limit the protection scope of the present invention. Any modification, equivalent replacement, and improvement made by persons skilled in the art without departing from the spirit and scope of the present invention shall fall within the protection scope of the present invention.

What is claimed is:

1. An environmental protection announcement system, comprising:
an announcement device, comprising a data processing unit, and being in information connection with a transmission unit;
an electronic paper display unit, being in information connection with the data processing unit;
a power supply control unit, being in electrical connection with the transmission unit, the data processing unit and the electronic paper display unit; and
an information carrier, comprising a memory unit for storing announcement information, a power storage unit for storing electric energy and supplying a small amount of electric energy, an electric energy control unit being in electrical connection with the power storage unit, and a corresponding transmission unit for transferring the announcement information,
wherein the announcement device is in information connection with the corresponding transmission unit of the information carrier through the transmission unit, the power storage unit of the information carrier supplies the small amount of electric energy stored to the announcement device so as to drive the electronic paper display unit to operate, and the memory unit of the information carrier transfers the announcement information stored to the announcement device so as to drive information announced by the electronic paper display unit to change.

2. The environmental protection announcement system according to claim 1, wherein the announcement device comprises another transmission unit.

3. The environmental protection announcement system according to claim 1, wherein the information carrier comprises an image display unit, being in connection with a computing and processing unit and the electric energy control unit respectively.

4. The environmental protection announcement system according to claim 1, wherein the information carrier comprises a function control unit, being in connection with a computing and processing unit.

5. The environmental protection announcement system according to claim 1, wherein the information carrier comprises a wireless communication unit, being in connection with a computing and processing unit and the electric energy control unit respectively.

6. The environmental protection announcement system according to claim 1, wherein the electronic paper display unit is flexible electrophoretic electronic paper.

7. The environmental protection announcement system according to claim 1, wherein the power storage unit is a chargeable electricity storage element.

8. The environmental protection announcement system according to claim 1, wherein the information carrier is a mobile memory device.

9. An implementation method of an environmental protection announcement system, comprising:
a step of editing information, wherein an information carrier is made to be in information connection with an information apparatus, and the information apparatus is capable of editing content of announcement information;
a step of loading the announcement information into the information carrier, wherein the edited announcement information is stored in a memory unit of the information carrier;
a step of connection detection, wherein information connection and electrical connection of the information carrier with an announcement device are completed, and at the beginning of connection, the information carrier detects whether the device connected thereto is the announcement device, and if the detection result is NO, the information carrier dose not perform any operation; if the detection result is YES, the information carrier performs a next step; and
a step of updating announcement content, wherein it is confirmed that the information carrier and the announcement device are in connection, an electric energy control unit of the information carrier transfers electric energy stored in a power storage unit to the announcement device through a corresponding transmission unit so as to drive the announcement device to operate, the information carrier transfers the announcement information to the announcement device, and a data processing unit processes the announcement information to generate image information, so as to enable an electronic paper display unit to operate, and further change information announced by the announcement device.

10. The implementation method of an environmental protection announcement system according to claim 9, wherein between the step of loading the announcement information into the information carrier and the step of connection detection, the method comprises a step of information carrier recognition.
